(19) United States
(12) Patent Application Publication
(10) Pub. No.: US 2012/0067667 A1
(43) Pub. Date: Mar. 22, 2012

(54) Safety device and method of using same

(76) Inventor: Philippe Marcoux, Beloeil (CA)

(21) Appl. No.: 13/137,797

(22) Filed: Sep. 14, 2011

(30) Foreign Application Priority Data
Sep. 16, 2010 (GB) 1015446.6

(51) Int. Cl. A62B 35/00; F16M 13/02; F16B 45/02

(52) U.S. Cl. 182/3; 248/237

(57) ABSTRACT

A safety device securable on a roof with a fastener, comprising: an anchor bracket having a substantially L-shaped configuration, the anchor bracket including a safety line attachment portion having a substantially plate-shaped configuration and defining a safety line attachment aperture extending therethrough; and a roof attachment portion having a substantially plate-shaped configuration. The roof attachment portion defines a plurality of substantially elongated slots each extending inwardly from one of the roof attachment portion side edges for receiving the fastener therethrough when the fastener is secured to the roof. The slots are slanted so as to extend away from the roof attachment portion proximal end in a direction leading away from the one of the roof attachment portion side edges. A safety line is attached to the safety line attachment portion.

The present application claims priority from UK Request Application Serial Number 1015446.6 filed on Sep. 16, 2010, the contents of which is hereby incorporated by reference in its entirety.

### FIELD OF THE INVENTION

The present invention relates generally to safety equipment and, more particularly, to a safety device that may be advantageously used by roof workers, and a method of using same.

### BACKGROUND

The prior art propose numerous safety line anchoring means. The safety line anchoring means of the prior art are generally represented by a anchoring bracket that is typically anchored to a top ridge or peak of a pitched roof.

While these prior art devices can generally fulfill the main objective of providing a safety line anchoring means for installation on a pitched roof, or the likes, they also entail one or more of the following disadvantages.

To securely install a safety line anchoring means of the prior art on a pitched roof on which a roofing job is planned, a roof worker first has to dangerously climb to the peak of the pitched roof without being safely tethered through a securely anchored safety line before doing so.

While using a safety line anchoring means of the prior art thus secured to the peak portion of a pitched roof, a safety line may often get entangled in obstacles such as, for examples, dormer windows and roof vents, positioned between the anchor point and various working areas distantly located near a lower edge of the roof.

Safety line anchoring means of the prior art generally have relatively large dimensions and, thus, are generally not easy and/or safe to be carried along by a roof worker who, additionally to having to hold the anchor or anchors with one or both hands, has to precariously climb up to the peak of the pitched roof for installing them.

Against this background, there exist a need for an improved safety device. An object of this invention is to provide such a safety device.

### SUMMARY OF THE INVENTION

In a broad aspect, the invention provides a safety device securable on a roof with a fastener, the safety device comprising: an anchor bracket having a substantially L-shaped configuration, the anchor bracket including a safety line attachment portion having a substantially plate-shaped configuration and defining a safety line attachment aperture extending therethrough; and a roof attachment portion having a substantially plate-shaped configuration, the roof and safety line attachment portions extending in a substantially perpendicular relationship relative to each other, the roof attachment portion defining opposed roof attachment portion proximal and distal ends and opposed roof attachment portion side edges extending therebetween, the safety line attachment portion being provided substantially adjacent the roof attachment portion proximal end. The roof attachment portion defines a plurality of substantially elongated slots each extending inwardly from one of the roof attachment portion side edges for receiving the fastener therethrough when the fastener is secured to the roof. The slots are slanted so as to extend away from the roof attachment portion proximal end in a direction leading away from the one of the roof attachment portion side edges. A safety line is attached to the safety line attachment portion and received through the safety line attachment aperture.

Typically, the safety line is removably attached to the anchor bracket. For example, the safety line includes a carabiner removably attached to the anchor bracket and a rope attached to the carabiner.

In some embodiments of the invention, the slots are substantially parallel to each other.

In some embodiments of the invention, the slots are terminated with an enlarged portion opposed to the one of the roof attachment portion side edges. For example, the enlarged portion is substantially disc-shaped. Typically, the enlarged portions and the safety line attachment aperture are substantially laterally aligned with each other between the roof attachment portion side edges.

In some embodiments of the invention, the safety line attachment portion is longitudinally shorter than the roof attachment portion. Also, typically, the safety line attachment portion is substantially perpendicular to the roof attachment portion side edges.

Typically, the proposed safety device is of relatively small size and relatively easy to use, which render the safety device substantially easy and safe to carry, install, relocate and be operatively used by a roof worker having to work in precarious locations such as on a pitched roof.

The substantially L-shaped configuration of the anchor bracket allows a roof worker to safely carry more than one anchor bracket of the present invention by simply assembling them in a stacked fashion, with one elongated end of the thus stacked anchor brackets conveniently and securely inserted, for example, in a standard loop or pocket of a tools belt.

In some embodiments of the invention, the proposed safety device allows a worker to avoid having first to dangerously climb to the top of a pitched roof for installing a safety line anchoring means without being safely tethered through a securely anchored safety line and provides a relatively high degree of safety and mobility on the roof without interference with work or material.

In some embodiments of the invention, the proposed safety device does not require to be displaced often around a work area where, for example, roofing shingles are installed, since the plate-shaped roof attachment portion of the anchor bracket allows the latter to be left in place between overlapping portions of shingles as the installation work progress up the pitched roof.

In some embodiments of the invention, the proposed safety device allows to avoid the safety line from becoming entangled with an obstacle such as a dormer window or a roof vent, since the anchor point may be easily selectively positioned close to the roof worker.

In some embodiments of the invention, the proposed safety device is also relatively easy and economical to manufacture.

In another broad aspect, the invention provides a method of using a safety device as recited hereinabove with the fastener, the fastener defining a substantially elongated fastener body and a fastener head provided at one end of the fastener body, the fastener head being larger than the enlarged portion. The method includes: partially inserting the fastener in the roof with the fastener head spaced apart from the roof; and with the fastener partially inserted in the roof, attaching the anchor bracket to the roof by inserting the fastener body in one of the slots and sliding the anchor bracket along the fastener body until the fastener body is located in the enlarged portion

In some embodiments of the invention, after attaching the anchor bracket to the roof, the fastener is further inserted in the roof until the fastener head is substantially adjacent the roof attachment portion.

In some embodiments of the invention, the method further comprises inserting the fastener in the roof until the fastener head abuts against the roof attachment portion.

In some embodiments of the invention, the fastener is nail, inserting the fastener in the roof including hammering the nail. However, in other embodiments of the invention, the fastener is any other suitable fastener, such as for example a screw.

In some embodiments of the invention, the method further comprises inserting an other fastener through the enlarged portion of another one of the slots and in the roof until the fastener head of the other fastener is substantially adjacent the roof attachment portion.

In some embodiments of the invention, the method further comprises removing the anchor bracket from the fastener by sliding the anchor bracket along the roof until the fastener body is outside of the slot.

In yet another broad aspect, the invention provides an anchor bracket securable on a roof with a fastener and usable with a safety line attachable to the anchor bracket, the anchor bracket comprising: a safety line attachment portion having a substantially plate-shaped configuration and defining a safety line attachment aperture extending therethrough for attaching the safety line thereto; and a roof attachment portion having a substantially plate-shaped configuration, the roof and safety line attachment portions extending in a substantially perpendicular relationship relative to each other, the roof attachment portion defining opposed roof attachment portion proximal and distal ends and opposed roof attachment portion side edges extending therebetween, the safety line attachment portion being provided substantially adjacent the roof attachment portion proximal end; the roof attachment portion defining a plurality of substantially elongated slots each extending inwardly from one of the roof attachment portion side edges for receiving the fastener therethrough when the fastener is secured to the roof, the slots being slanted so as to extend away from the roof attachment portion proximal end in a direction leading away from the one of the roof attachment portion side edges.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

FIG. 1, in perspective view, illustrates a safety device in accordance with an embodiment of the present invention;

FIG. 2, in a perspective view, illustrates a step in the use of the safety device shown in FIG. 1;

FIG. 3, in a perspective view, illustrates another step in the use of the safety device shown in FIG. 1;

FIG. 4, in a perspective view, illustrates yet another step in the use of the safety device shown in FIG. 1; and

FIG. 5, in a perspective view, illustrates yet another step in the use of the safety device shown in FIG. 1.

### DETAILED DESCRIPTION

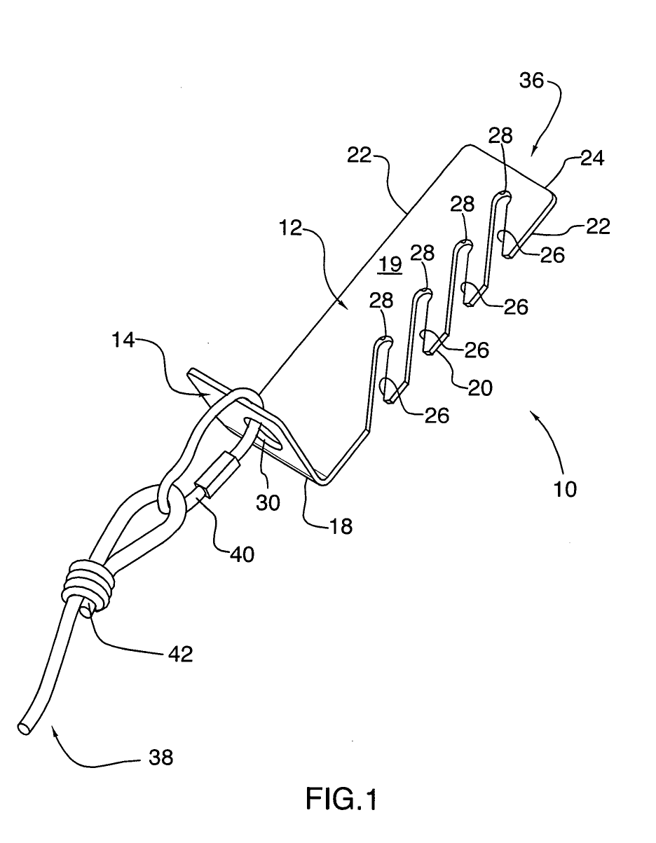

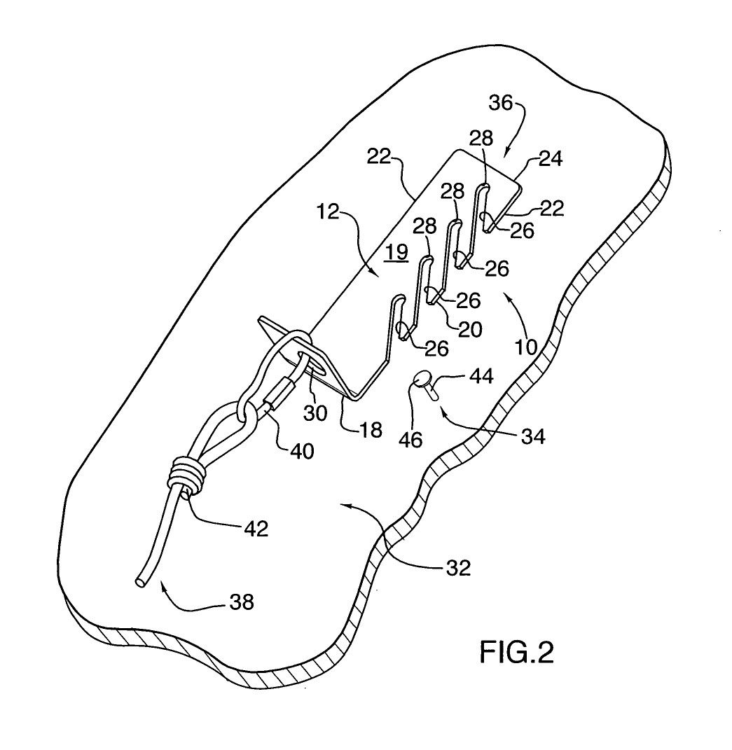

FIG. 1 shows various aspects of a safety device 10 in accordance with the present invention, which may be advantageously used by roof workers (not shown in the drawings) working on a pitched roof 32 (seen in FIGS. 2 to 5). The safety device 10 is securable on the roof 32 with one or more fasteners 34 (also seen in FIGS. 2 to 5). The safety device 10 includes an anchor bracket 36 having a substantially L-shaped configuration and a safety line 38.

The anchor bracket 36 includes a roof attachment portion 12 having a substantially plate-shaped configuration, for example a substantially elongated and rectangular configuration, and a safety line attachment portion 14 having also a substantially plate-shaped configuration extending therefrom. The roof and safety line attachment portions 12 and 14 extend in a substantially perpendicular relationship relative to each other.

The roof attachment portion 12 defines a top surface 19 and a bottom surface 20. The roof attachment portion 12 also defines opposed roof attachment portion proximal and distal ends 18 and 24 and opposed roof attachment portion side edges 22 extending therebetween. The safety line attachment portion 14 is provided substantially adjacent the roof attachment portion proximal end 18.

The roof attachment portion 12 is further provided with at least one, but typically a plurality of substantially elongated slots 26 that are inwardly extending from a side edge 22 thereof. The slots 26 are provided for receiving the fasteners 34 therethrough when the fasteners are secured to the roof 32. The slots 26 are slanted so as to extend away from the roof attachment portion proximal end 18 in a direction leading away from the one of the roof attachment portion side edges 22 from which they extend. The relative angle between the slots 26 and the roof attachment portion side edge 22 from which they extend, may be between twenty and seventy degrees. For example, the relative angle is typically about forty-five degrees. The slots 26 are also typically substantially parallel to each other.

Furthermore the side edge 22 the slots 26 typically extend inwardly up to a substantially central position between the two roof attachment portion side edges 22, where they are terminated with an enlarged portion 28. The enlarged portion 28 is typically substantially disc-shaped.

The elongated portion of the slots 26 has a transversal dimension that is suitably sized for freely slidably engage therein the cross-section of the fasteners 34, for example in the form of a standard nail.

The safety line attachment portion 14 is provided with a safety line attachment aperture 30 extending therethrough for securely attaching thereto the safety line 38. Typically, the enlarged portions 28 and the safety line attachment aperture 30 are substantially laterally aligned with each other between the roof attachment portion side edges 22. This configuration increases the stability of the safety device 10. To further increase this stability, the safety line attachment portion 14 is also typically shorter than the roof attachment portion 12.

The safety line 38 is typically removably attached to the anchor bracket 36. For example, the safety line 38 includes a carabiner 40 removably attached to the anchor bracket 36 and a rope 42, partially shown in FIG. 1, attached to the carabiner 40.

The safety device 10 is typically made of a suitably rigid and rust proof material such as, for examples, aluminum, surface-treated steel or iron, or the likes, having a sufficient thickness and strength.

With reference to FIGS. 2 to 5, a method of using the safety device 10 of the present invention is as follows. The fastener 34 a substantially elongated fastener body 44 and a fastener head 46 provided at one end of the fastener body 44, the fastener head 46 being larger than a width of the slots 26 and larger than the enlarged portions 28. For example a suitable fastener 34 is a nail, which is used as a typical fastener in the remainder of this example of use.

In a first operation, as seen in FIG. 2, a roof worker positioned on a pitched surface portion of a roof 32 hammers the fastener 34 of sufficient size and strength into the surface such that it is sufficiently distanced from the working area, yet within the maximum length of the safety line 38 of his or her safety harness. Furthermore, the worker takes care not to fully hammer in the fastener 34 into the surface of the roof 32 such that the fastener head 46 is spaced apart from the roof 32 and left at a sufficient distance therefrom that is slightly greater than the thickness of the roof attachment portion 12 of the anchor bracket 36.

In a second operation, also as seen in FIG. 2, the roof worker attaches the anchor bracket 36 to the roof 32 by positioning the bottom surface 20 of the anchor bracket 36 in abutting engagement with the top surface of the roof 32 with its distal end 24 thereof substantially oriented towards the upper portion of the pitched roof 32, and the roof attachment portion side edge 22 with the slots 26 proximal the fastener body 44 of the fastener 34.

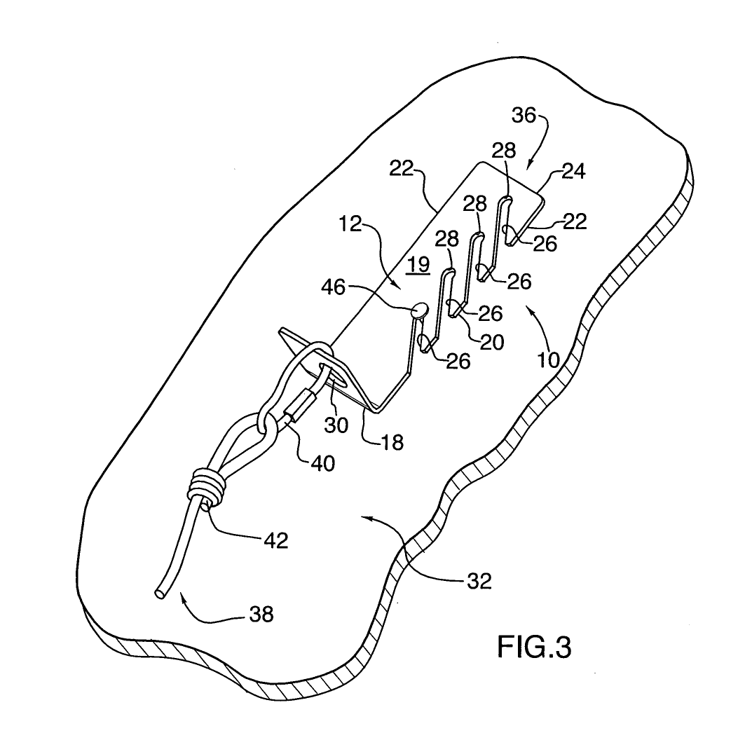

In a third operation, as seen in FIG. 3, the roof worker slidably engages a selected slot 26 on the fastener body 44 of the fastener 34 until the latter is fully engaged within the enlarged portion 28 of the slot 26.

In a fourth operation, the worker may then attach the carabiner 40 to the safety line attachment aperture 30 and then safely start to work. However in other embodiments, the carabiner 40 is already attached to the safety line attachment aperture 30 when attachment of the anchor bracket to the roof 32 begins.

In some embodiments of the invention, the roof worker further inserts the fastener 34 in the roof 32 until the fastener head 46 is substantially adjacent the roof attachment portion 12, by for example abutting against the roof attachment portion 12.

Hence, the worker has a relatively high degree of safety and mobility on the roof 32, without interference with work or material that is located within a radius around the fastener 34 that is substantially equivalent to the length of the safety line 38.

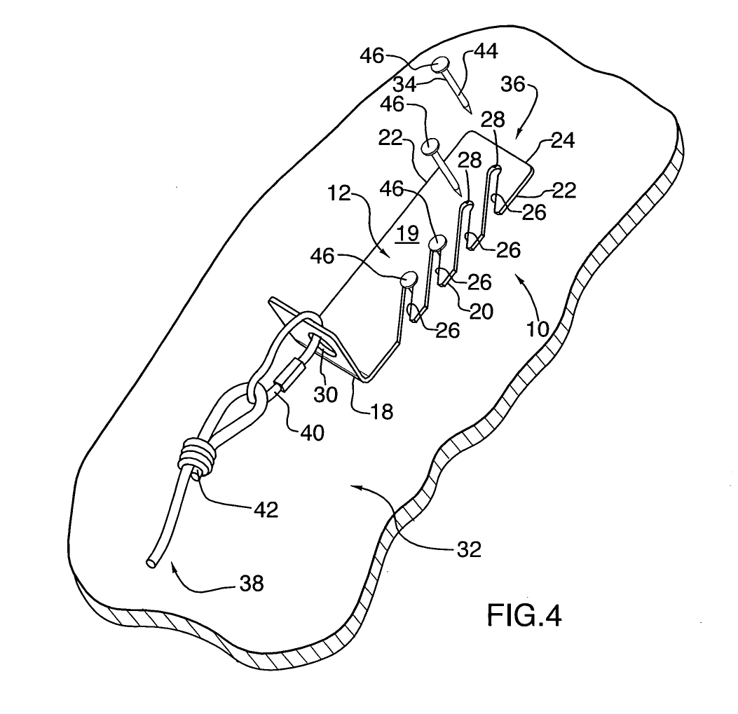

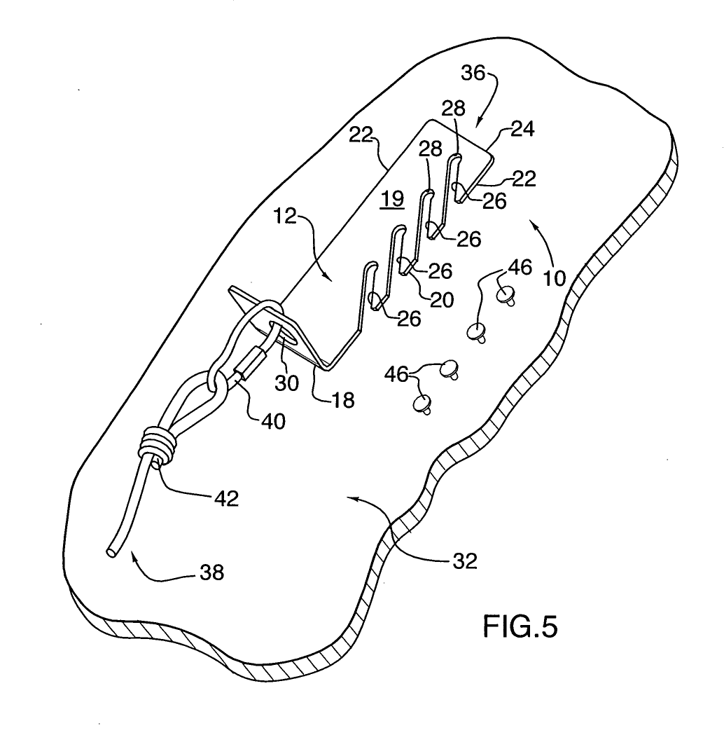

When required, the worker may safely finely adjust the maximum distance separating his or her harness relative to the fastener 34 anchored in the roof 32, by single handedly disengaging the anchor bracket 36 from the fastener 34 by sliding the anchor bracket 36 along the roof 32 until the fastener 34 is outside of the slot 26, as seen in FIG. 5, and then re-engaging the fastener 34 through another, more suitable slot 26. In yet other embodiments of the invention, as seen in FIG. 4, other fasteners are hammered in other slots 26 to further secure the anchor bracket 36 to the roof 32.

Once the worker has to work around another area of the roof 32 that is substantially too far relative to the maximum length of the safety line 38, the anchor bracket 36 may, first, be slidably disengaged from the fastener 34, followed with the fastener 34 being removed and hammered back into the selected portion of the roof where work must resume and, finally, engage the anchor bracket 36 back on the fastener 34. This displacement operation of the anchor bracket 36 may be executed all the while the safety line 38 remains attached to the latter.

Typically, a roof worker will work slightly below the anchor bracket 36, such as when installing roofing shingles or the like, from a bottom edge portion to a top portion of a pitched roof 32. Thus, the roof worker may periodically change the position of the anchor bracket 36 upwardly on a portion of the roof 32 that is not yet covered with shingles.

Advantageously, if desired the installation of roofing shingles may progress upwardly and above the position of the safety device 10 without having to relocate the latter since the plate-shaped roof attachment portion 12 may be left in place between overlapping portions of shingles as the installation work progress up the pitched roof.

Furthermore, the anchor bracket 36 of the present invention, having a substantially L-shaped configuration, allows a roof worker to safely carry more than one anchor bracket 36 by simply assembling them in a stacked fashion in a standard loop or pocket of his or her tools belt.

Although the present invention has been described hereinabove by way of preferred embodiments thereof, it can be modified, without departing from the spirit and nature of the subject invention as defined in the appended claims.

What is claimed is:

1. A safety device securable on a roof with a fastener, said safety device comprising:
an anchor bracket having a substantially L-shaped configuration, said anchor bracket including
a safety line attachment portion having a substantially plate-shaped configuration and defining a safety line attachment aperture extending therethrough; and
a roof attachment portion having a substantially plate-shaped configuration, said roof and safety line attachment portions extending in a substantially perpendicular relationship relative to each other, said roof attachment portion defining opposed roof attachment portion proximal and distal ends and opposed roof attachment portion side edges extending therebetween, said safety line attachment portion being provided substantially adjacent said roof attachment portion proximal end;
said roof attachment portion defining a plurality of substantially elongated slots each extending inwardly from one of said roof attachment portion side edges for receiving said fastener therethrough when said fastener is secured to said roof, said slots being slanted so as to extend away from said roof attachment portion proximal end in a direction leading away from said one of said roof attachment portion side edges; and
a safety line attached to said safety line attachment portion and received through said safety line attachment aperture.

2. The safety device as defined in claim 1, wherein said safety line is removably attached to said anchor bracket.

3. The safety device as defined in claim 2, wherein said safety line includes a carabiner removably attached to said anchor bracket and a rope attached to said carabiner.

4. The safety device as defined in claim 1, wherein said slots are substantially parallel to each other.

5. The safety device as defined in claim 1, wherein said slots are terminated with an enlarged portion opposed to said one of said roof attachment portion side edges.

6. The safety device as defined in claim 5, wherein said enlarged portion is substantially disc-shaped.

7. The safety device as defined in claim 5, wherein said enlarged portions and said safety line attachment aperture are substantially laterally aligned with each other between said roof attachment portion side edges.

8. The safety device as defined in claim 1, wherein said safety line attachment portion is longitudinally shorter than said roof attachment portion.

9. The safety device as defined in claim 1, wherein said safety line attachment portion is substantially perpendicular to said roof attachment portion side edges.

10. A method of using a safety device as defined in claim 1 with said fastener, said fastener defining a substantially elongated fastener body and a fastener head provided at one end of said fastener body, said fastener head being larger than said enlarged portion, said method comprising:
partially inserting said fastener in said roof with said fastener head spaced apart from said roof; and
with said fastener partially inserted in said roof, attaching said anchor bracket to said roof by inserting said fastener body in one of said slots and sliding said anchor bracket along said fastener body until said fastener body is located in said enlarged portion.

11. The method as defined in claim 10, further comprising, after attaching said anchor bracket to said roof, further inserting said fastener in said roof until said fastener head is substantially adjacent said roof attachment portion.

12. The method as defined in claim 11, further comprising inserting said fastener in said roof until said fastener head abuts against said roof attachment portion.

13. The method as defined in claim 10, wherein said fastener is nail, inserting said fastener in said roof including hammering said nail.

14. The method as defined in claim 10, further comprising inserting an other fastener through said enlarged portion of another one of said slots and in said roof until said fastener head of said other fastener is substantially adjacent said roof attachment portion.

15. The method as defined in claim 10, further comprising removing said anchor bracket from said fastener by sliding said anchor bracket along said roof until said fastener body is outside of said slot.

16. An anchor bracket securable on a roof with a fastener and usable with a safety line attachable to said anchor bracket, said anchor bracket comprising:
a safety line attachment portion having a substantially plate-shaped configuration and defining a safety line attachment aperture extending therethrough for attaching said safety line thereto; and
a roof attachment portion having a substantially plate-shaped configuration, said roof and safety line attachment portions extending in a substantially perpendicular relationship relative to each other, said roof attachment portion defining opposed roof attachment portion proximal and distal ends and opposed roof attachment portion side edges extending therebetween, said safety line attachment portion being provided substantially adjacent said roof attachment portion proximal end;
said roof attachment portion defining a plurality of substantially elongated slots each extending inwardly from one of said roof attachment portion side edges for receiving said fastener therethrough when said fastener is secured to said roof, said slots being slanted so as to extend away from said roof attachment portion proximal end in a direction leading away from said one of said roof attachment portion side edges.
